(19) United States
(12) Patent Application Publication
(10) Pub. No.: US 2005/0136251 A1
(43) Pub. Date: Jun. 23, 2005

(54) Heat-peelable pressure-sensitive adhesive sheet

(75) Inventors: Tomoko Kishimoto, Ibaraki-shi (JP); Masakazu Tanimoto, Ibaraki-shi (JP); Yukio Arimitsu, Ibaraki-shi (JP); Michirou Kawanishi, Ibaraki-shi (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION

(21) Appl. No.: 11/003,765

(22) Filed: Dec. 6, 2004

(30) Foreign Application Priority Data
Dec. 19, 2003 (JP) P. 2003-422313

(51) Int. Cl. B32B 7/12; B32B 15/04; B32B 3/26

(52) U.S. Cl. 428/343

(57) ABSTRACT

A heat-peelable pressure-sensitive adhesive sheet, which comprises a substrate, a heat-expandable adhesive layer formed on at least one surface thereof, and a surfactant, wherein the surfactant is contained in the heat-expandable adhesive layer as an adhesive surface.

### FIELD OF THE INVENTION

The present invention relates to a heat-peelable pressure-sensitive adhesive sheet which has suitable adhesivity as an adhesive sheet used in processing a semiconductor wafer and can easily be peeled by heat treatment and which can reduce contamination on a surface of the semiconductor wafer after peeling by water washing.

### BACKGROUND OF THE INVENTION

A heat-peelable pressure-sensitive adhesive sheet in which an adhesive layer containing a foaming agent or an expanding agent such as heat-expandable microcapsules is formed on a substrate has been so far known (refer to patent documents 1 to 5). This heat-peelable pressure-sensitive adhesive sheet is an adhesive sheet in which adhesivity and peelability after use are consistent. Specifically, after a purpose of adhering an adhesion body is attained, the adhesive layer containing a foaming agent or an expanding agent such as heat-expandable microcapsules is heated, whereby the adhesive layer is foamed or expanded, the surface of the adhesive layer is changed to an irregular surface to decrease adhesivity owing to the decrease in adhesion area with the adhesion body, so that the adhesion body can easily be separated. Accordingly, the sheet has been used for various purposes such as fixing (temporal fixing or the like) in processing electronic parts, materials thereof or the like and fixing (temporal fixing or the like) in circulation such as transportation.

However, when such an ordinary heat-peelable pressure-sensitive adhesive sheet is used in dicing of a semiconductor wafer (silicon wafer or the like), polishing of a reverse surface thereof or the like, such a contamination problem occurs that ultrafine contamination (especially, organic contamination) which cannot be visually observed heavily remains on the surface of the semiconductor wafer from which the adhesive sheet has been peeled by heat treatment, and electronic parts produced are sometimes unsuitable for actual use. They have been serious problems.

[Patent Document 1]

JP-B-50-13878
   [Patent Document 2]
JP-B-51-24534
   [Patent Document 3]
JP-A-56-61468
   [Patent Document 4]
JP-A-56-61469
   [Patent Document 5]
JP-A-60-252681

### SUMMARY OF THE INVENTION

Accordingly, it is an object of the invention to provide a heat-peelable pressure-sensitive adhesive sheet which can easily be peeled by heat treatment and enables contamination on a surface of an adhesion body after peeling to be easily reduced by water washing.

Another object of the invention is to provide a heat-peelable pressure-sensitive adhesive sheet which enables, when used in a step of cutting a reverse surface of a semiconductor wafer, contamination on a surface of the semiconductor wafer to be easily reduced by washing with water such as cooling water or cleaning water used in a dicing step after peeling by heat treatment without providing a cleaning step.

The present inventors have assiduously conducted investigations to attain the foregoing objects, and have consequently found that when a specific component is incorporated in an adhesive layer as an adhesive surface in a heat-peelable pressure-sensitive adhesive sheet used in temporally fixing a semiconductor wafer, the surface of the semiconductor wafer, even when contaminated, can easily be cleaned by water washing after heat peeling. This finding has led to the completion of the invention.

That is, the invention has the following constitution.

(1) A heat-peelable pressure-sensitive adhesive sheet, which comprises a substrate, a heat-expandable adhesive layer formed on at least one surface thereof, and a surfactant, wherein the surfactant is contained in the heat-expandable adhesive layer as an adhesive surface.

(2) A heat-peelable pressure-sensitive adhesive sheet, which comprises a substrate, a heat-expandable adhesive layer formed on at least one surface thereof, a surfactant and a non-heat-expandable adhesive layer, wherein the surfactant is contained in the non-heat-expandable adhesive layer as an adhesive surface on the heat-expandable adhesive layer.

(3) The heat-peelable pressure-sensitive adhesive sheet according to the above (1) or (2), which is a heat-peelable pressure-sensitive adhesive sheet used in processing a semiconductor wafer.

(4) The heat-peelable pressure-sensitive adhesive sheet according to any one of the above (1) to (3), wherein when the heat-peelable pressure-sensitive adhesive sheet is adhered to the semiconductor wafer, a carbon element ratio R_{C1} (%) on a surface of the semiconductor wafer, as measured by XPS, after the heat-peelable pressure-sensitive adhesive sheet is peeled from the semiconductor wafer by heating and the semiconductor wafer is further washed with water satisfies the following relational expression (1):
R_{C11}≦50+R_{C2} (1)
wherein R_{C2} represents a carbon element ratio (%) on the surface of the semiconductor wafer, as measured by XPS, before adhered to the heat-peelable pressure-sensitive adhesive sheet.

(5) The heat-peelable pressure-sensitive adhesive sheet according to any of the above (1) to (4), wherein when the heat-peelable pressure-sensitive adhesive sheet is adhered to the semiconductor wafer, the semiconductor wafer is a silicon wafer, and a carbon element ratio R_{C1}^{Si} on a surface of the silicon wafer, as measured by XPS, after the heat-peelable pressure-sensitive adhesive sheet is peeled from the silicon wafer by heating and the silicon wafer is further washed with water satisfies the following relational expression (2):
R_{C1}^{Si}≦2.5R_{Si} (2)
wherein R_{Si} represents a silicon element ratio (%) on the surface of the silicon wafer, as measured by XPS, after the heat-peelable pressure-sensitive adhesive sheet is peeled from the silicon wafer by heating and the silicon wafer is further washed with water.

(6) The heat-peelable pressure-sensitive adhesive sheet according to any of claims 1 to 5, wherein at least one surfactant having HLB of 10 or more is contained as the surfactant.

In the heat-peelable pressure-sensitive adhesive sheet of the invention, the adhesive sheet can easily be peeled by heat treatment, and contamination on the surface of the adhesion body after peeling can easily be reduced by water washing. Especially when the sheet is used in a step of cutting the reverse surface of the semiconductor wafer, contamination on the surface of the semiconductor wafer can easily be reduced by washing with water such as cooling water or cleaning water used in a dicing step after peeling by heat treatment without providing a cleaning step.

### BRIEF DESCRIPTION OF THE DRAWINGS

FIG. 1 is a schematic sectional view showing an example of a heat-peelable pressure-sensitive adhesive sheet of the invention.

FIG. 2 is a schematic sectional view showing an example of a heat-peelable pressure-sensitive adhesive sheet of the invention.

In the drawings, sign 1 is a heat-peelable pressure-sensitive adhesive sheet, sign 2 is a substrate (support substrate), sign 3 is a surfactant-containing heat-expandable adhesive layer, sign 4 is a separator (release liner), sign 5 is a heat-peelable pressure-sensitive adhesive sheet, sign 6 is a substrate (support substrate), sign 7 is a heat-expandable adhesive layer, sign 8 is a surfactant-containing adhesive layer and sign 9 is a separator (release liner).

### DETAILED DESCRIPTION OF THE INVENTION

The embodiments of the invention are described in detail below by referring to the drawings as required. Incidentally, the same reference numerals are sometimes allotted to the same members or parts.

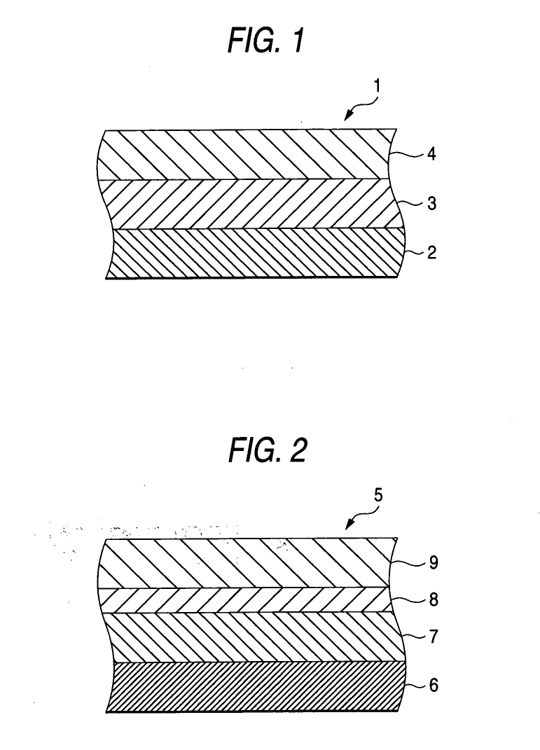

The heat-peelable pressure-sensitive adhesive sheet of the invention has, as shown in FIGS. 1 and 2, a heat-expandable adhesive layer containing a surfactant (hereinafter sometimes referred to as “a surfactant-containing heat-expandable adhesive layer”) or anon-heat-expandable adhesive layer formed on a heat-expandable adhesive layer and containing a surfactant (hereinafter sometimes referred to as “a surfactant-containing adhesive layer”). FIGS. 1 and 2 are each a schematic sectional view showing an example of the heat-peelable pressure-sensitive adhesive sheet of the invention. In FIG. 1, sign 1 is a heat-peelable pressure-sensitive adhesive sheet, sign 2 a substrate (support substrate), sign 3 a surfactant-containing heat-expandable adhesive layer, and sign 4 a separator (release liner). In FIG. 2, sign 5 is a heat-peelable pressure-sensitive adhesive sheet, sign 6 a substrate (support substrate), sign 7 a heat-expandable adhesive layer, sign 8 a surfactant-containing adhesive layer, and sign 9 a separator (release liner).

The heat-peelable pressure-sensitive adhesive sheet 1 shown in FIG. 1 comprises the substrate 2, the surfactant-containing heat-expandable adhesive layer 3 formed on one surface of the substrate 2 and the separator 4 protecting the surface of the surfactant-containing heat-expandable adhesive layer 3. The heat-peelable pressure-sensitive adhesive sheet 5 shown in FIG. 2 comprises the substrate 6, the heat-expandable adhesive layer 7 formed on one surface of the substrate 6, the surfactant-containing adhesive layer 8 formed on the heat-expandable adhesive layer 7 and the separator 9 protecting the surface of the surfactant-containing adhesive layer 8.

Thus, the heat-peelable pressure-sensitive adhesive sheet of the invention has the structure that the heat-expandable adhesive layer is formed on at least one surface of the substrate and the surfactant is contained in at least the adhesive layer (the heat-expandable adhesive layer, the non-heat-expandable adhesive layer formed on the heat-expandable adhesive layer or the like) as the adhesive surface.

(Substrate)

The substrate such as the substrate 2 shown in FIG. 1 or the substrate 6 shown in FIG. 2 can be used as a support body of various adhesive layers such as the heat-expandable adhesive layer (the surfactant-containing heat-expandable adhesive layer 3, the heat-expandable adhesive layer 7 or the like) and the non-heat-expandable adhesive layer (the surfactant-containing adhesive layer 8 or the like). Incidentally, the substrate may be in the form of a monolayer or a laminate.

As the substrate, it is possible to use appropriate thin materials, for example, paper-type substrates such as paper; fibrous substrates such as a woven fabric, a non-woven fabric, a felt and a net; metallic substrates such as a metallic foil and a metallic plate; plastic substrates such as a plastic film and a plastic sheet; rubbery substrates such as a rubber sheet; foams such as a foamed sheet and laminates thereof (especially, a laminate of a plastic substrate and another substrate, a laminate of plastic films (or sheets) and the like); and the like. The substrate excellent in heat resistance which is not melted at a heat treatment temperature of the heat-expandable adhesive layer is preferable in view of handleability after heating. As the substrate, plastic substrates such as a plastic film and a plastic sheet can preferably be used. Examples of the material in such plastic substrates include olefinic resins using as a monomer component α-olefins such as polyethylene (PE), polypropylene (PP), an ethylene-propylene copolymer and an ethylene-vinyl acetate copolymer (EVA); polyesters such as polyethylene terephthalate (PET), polyethylene naphthalate (PEN) and polybutylene terephthalate (PBT); polyvinyl chloride (PVC); polyphenylene sulfide (PPS); amide resins such as polyamide (nylon) and wholly aromatic polyamide (aramid); polyether ether ketone (PEEK); and the like. These materials may be used either singly or in combination of two or more thereof.

When the plastic substrates are used as a substrate, deformability such as elongation may be controlled by stretching treatment. Further, when a radiation-curable substance is used in the heat-expandable adhesive layer or the like, it is preferable to use a substrate that does not hinder transmission of radiation.

The thickness of the substrate can properly be selected according to strength, flexibility and use purpose. For example, it is generally 1,000 μm or less (for example, from 1 to 1,000 μm), preferably from 1 to 500 μm, more preferably from 3 to 300 μm, especially from 5 to 250 μm. However, the thickness is not limited thereto.

For increasing adhesivity with various adhesive layers (various adhesive layers such as the surfactant-containing or surfactant-free heat-expandable adhesive layer and the surfactant-containing or surfactant-free non-heat-expandable adhesive layer) formed on the substrate, the surface of the substrate may be subjected to ordinary surface treatment, for example, oxidation treatment by a chemical or physical method such as chromic acid treatment, ozone exposure, flame exposure, high-voltage electric shock exposure or ionized radiation treatment, and to coating treatment with an undercoating agent. Further, for imparting releasability from various adhesive layers formed on the substrate, it may be subjected to coating treatment with a release agent such as a silicone based resin or a fluororesin.

In the invention, as shown in FIGS. 1 and 2, the heat-expandable adhesive layer (various heat-expandable adhesive layers such as the surfactant-containing heat-expandable adhesive layer and the surfactant-free heat-expandable adhesive layer) can be formed on at least one surface (one surface or both surfaces) of the substrate, and the substrate can be embedded inside the various heat-expandable adhesive layers.

(Heat-Expandable Adhesive Layer)

The heat-expandable adhesive layer such as the surfactant-containing heat-expandable adhesive layer 3 shown in FIG. 1 or the heat-expandable adhesive layer 7 shown in FIG. 2 comprises at least an adhesive for imparting adhesivity and a foaming agent for imparting heat expansibility (especially heat-expandable microcapsules) Accordingly, the heat-peelable pressure-sensitive adhesive sheet is adhered to, for example, an adhesion body such as a semiconductor wafer, and the heat-expandable adhesive layer is then heated at an optional time to foam and/or expand the foaming agent such as heat-expandable microcapsules, whereby the heat-expandable adhesive layer is expanded. By this expansion, the adhesion area between the heat-expandable adhesive layer and the adhesion body (semiconductor wafer or the like) is decreased to decrease the adhesivity caused by the heat-expandable adhesive layer, making it possible to easily peel the heat-peelable pressure-sensitive adhesive sheet from the adhesion body. The surfactant-containing heat-expandable adhesive layer is ordinarily used as the heat-expandable adhesive layer to be adhered to the adhesion body.

Meanwhile, the heat-expandable adhesive layer (surfactant-free heat-expandable adhesive layer) is used to decrease the adhesivity caused by the surfactant-containing adhesive layer formed on the heat-expandable adhesive layer for being adhered to the adhesion body.

(Foaming Agent)

As the foaming agent, heat-expandable microcapsules can preferably be used. Such heat-expandable microcapsules can properly be selected from known heat-expandable microcapsules. As the heat-expandable microcapsules, a microcapsulated foaming agent can preferably be used in view of the easy mixing procedure. Examples of such heat-expandable microcapsules include microcapsules in which substances which are easily expanded by being gasified through heating, such as isobutane, propane and pentane, are included in elastic shells. The shells are often made of a heat-meltable substance or a substance which is ruptured by heat expansion. Examples of the substance forming the shells include a vinylidene chloride-acrylonitrile copolymer, polyvinyl alcohol, polyvinyl butyral, polymethyl methacrylate, polyacrylonitrile, polyvinylidene chloride, polysulfone and the like. The heat-expandable microcapsules can be produced by an ordinary method such as a coacervation method or an interfacial polymerization method. As the heat-expandable microcapsules, there is, for example, a commercial product under a trade name “Matsumoto Microsphere” (manufactured by Matsumoto Yushi Seiyaku K.K.).

For decreasing the adhesivity of the heat-expandable adhesive layer by heat treatment efficiently and stably, heat-expandable microcapsules having appropriate strength by which rupture does not occur until a volume expansion rate becomes more than 5 times, preferably more than 7 times, especially more than 10 times are advantageous.

The mixing amount of the heat-expandable microcapsules can properly be determined according to the degree of decrease in adhesivity. Specifically, the mixing amount of the heat-expandable microcapsules can be selected from the range of, for example, from 1 to 100 parts by weight (preferably from 5 to 80 parts by weight, more preferably from 10 to 50 parts by weight), based on 100 parts by weight of a base polymer of the adhesive constituting the heat-expandable adhesive layer.

The particle size (average particle size) of the heat-expandable microcapsules can properly be selected according to the thickness of the heat-expandable adhesive layer or the like. The average particle size of the heat-expandable microcapsules can be selected from the range of, for example, 100 μm or less (preferably 80 μm or less, more preferably from 1 to 50 μm, especially from 1 to 30 μm). The particle size of the heat-expandable microcapsules may be adjusted during formation of the heat-expandable microcapsules or by a step such as classification after formation.

In the invention, a foaming agent other than the heat-expandable microcapsules may be used along with the heat-expandable microcapsules or instead of the heat-expandable microcapsules. As this foaming agent, various foaming agents such as inorganic foaming agents and organic foaming agents can properly be used selectively. Typical examples of the inorganic foaming agents include ammonium carbonate, ammonium hydrogencarbonate, sodium hydrogencarbonate, ammonium nitrite, sodium boron hydroxide, various azides and the like. Typical examples of the organic foaming agents include water; chlorofluoroalkane compounds such as trichloromonofluoromethane and dichloromonofluoromethane; azo compounds such as azobisisobutyronitrile, azodicarbonamide and barium azodicarboxylate; hydrazine compounds such as p-toluenesulfonyl hydrazide, diphenylsulfone-3,3-disulfonyl hydrazide, 4,4′-oxybis(benzenesulfonylhydrazide) andallylbis(sulfonyl hydrazide); semicarbazide compounds such as p-toluylenesulfonyl semicarbazide and 4,4′-oxybis(benzenesulfonyl semicarbazide); triazole compounds such as 5-morphoryl-1, 2,3,4-thiatriazole; N-nitroso compounds such as N,N′-dinitrosopentamethylene tetramine and N,N′-dinitrosoterephthalamide; and the like.

(Adhesive)

As the adhesive which is used in various heat-expandable adhesive layers such as the surfactant-containing heat-expandable adhesive layer and the surfactant-free heat-expandable adhesive layer, an adhesive which does not suppress foaming and/or expansion of the foaming agent (especially the heat-expandable microcapsules) at the time of heating as much as possible is preferable. Examples of the adhesive include known adhesives such as a rubbery adhesive, an acrylic adhesive, a styrene-diene block copolymer adhesive, a vinyl alkyl ether adhesive, a silicone-based adhesive, a polyester-based adhesive, a polyamide-based adhesive, a urethane-based adhesive, a fluorine-based adhesive, and a creeping property-improved adhesive obtained by mixing these adhesives with a heat-meltable resin having a melting point of less than 200° C., and they may be used either singly or in combination of two or more thereof (refer to, for example, JP-A-56-61468, JP-A-61-174857, JP-A-63-17981 and JP-A-56-13040). Further, as the adhesive, a radiation-curable adhesive (or an energy ray-curable adhesive) is also available. These adhesives may be used either singly or in combination of two or more thereof.

In view of the balance of appropriate adhesivity before heat treatment and a decrease in adhesivity after heat treatment, a more preferable adhesive is an adhesive based on a polymer whose dynamic elasticity is in the range of from 0.5 to 100 (Pa) [from 50,000 to 10,000,000 (dyn/cm²)] at from room temperature to 150° C.

The adhesive constituting the heat-expandable adhesive layer may contain, other than a polymer component such as an adhesive component (base polymer), appropriate additives, depending on the type of the adhesive and the like, such as a crosslinking agent, an adhesivity-imparting resin (resins which are solid, semi-solid or liquid at room temperature, such as a rosin derivative resin, a polyterpene resin, a petroleum resin and an oil-soluble phenolic resin), a plasticizer, a filler and an antioxidant. The heat-expandable adhesive layer using a polymer with a functional group introduced as a base polymer and crosslinked by addition of a crosslinking agent has cohesive force and can reduce contamination caused by the heat-expandable adhesive layer. However, in the use in which transfer of the additives into the adhesion body poses a problem as in case of desiring low contamination, an adhesive of a composition that does not contain the additives such as the adhesivity-imparting resin and the plasticizer is also available. The crosslinking agent is not particularly limited.

Examples thereof include isocyanate-based crosslinking agents such as tolylene diisocyanate, trimethylolpropane triisocyanate and diphenylmethane diisocyanate; epoxy-based crosslinking agents such as polyethylene glycol diglycidyl ether, diglycidyl ether and trimethylolpropane triglycidyl ether; melamine-based crosslinking agents such as an alkyl ether melamine compound; metal salt-based crosslinking agents; metal chelate-based crosslinking agents; amino-based crosslinking agents; peroxide-based crosslinking agents; coupling agent-type crosslinking agents such as a silane coupling agent; and the like.

As the adhesive, a rubbery adhesive and an acrylic adhesive (especially an acrylic adhesive) can preferably be used. Specifically, the rubbery adhesive uses a natural rubber or a synthetic rubber as a base polymer. Examples of the synthetic rubber include a polyisoprene rubber, a styrene.butadiene (SB) rubber, a styrene.isoprene (SI) rubber, a styrene.isoprene.styrene block copolymer (SIS) rubber, a styrene.butadiene.styrene block copolymer (SBS) rubber, a styrene.ethylene.butylene.styrene block copolymer (SEBS) rubber, a styrene.ethylene.propylene.styrene block copolymer (SEPS) rubber, a styrene.ethylene.propylene block copolymer (SEP) rubber, a regenerated rubber, a butyl rubber, polyisobutylene, these rubbers which are modified, and the like.

The acrylic adhesive specifically contains acrylic polymers as a base polymer. The acrylic polymers contain an alkyl (meth)acrylate as a main component of a monomer and, as required, a copolymerizable monomer as a copolymerizable component. The acrylic polymers may be used either singly or in combination of two or more thereof. With respect to the alkyl (meth)acrylate as the monomer main component, for example, a C₁₋₂₀ alkyl (meth)acrylate can preferably be used.

Examples of the C₁₋₂₀ alkyl (meth) acrylate include methyl (meth)acrylate, ethyl (meth)acrylate, propyl (meth)acrylate, isopropyl (meth)acrylate, n-butyl (meth)acrylate, isobutyl (meth)acrylate, sec-butyl (meth)acrylate, t-butyl (meth)acrylate, pentyl (meth)acrylate, isopentyl (meth)acrylate, neopentyl (meth)acrylate, hexyl (meth)acrylate, heptyl (meth)acrylate, octyl (meth)acrylate, isooctyl (meth)acrylate, 2-ethylhexyl (meth)acrylate, nonyl (meth) acrylate, isononyl (meth) acrylate, decyl (meth) acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth) acrylate, octadecyl (meth)acrylate, nonadecyl (meth)acrylate, eicosyl (meth)acrylate and the like. C₁₋₂₀ alkyl (meth)acrylates may be used either singly or in combination of two or more thereof.

The copolymerizable monomer as a copolymerizable component which is contained in the acrylic polymer is properly selected according to the type of the alkyl (meth)acrylate. Examples of the copolymerizable monomer include (meth) acrylic acid alicyclic hydrocarbon esters such as cyclohexyl (meth)acrylate, bornyl (meth)acrylate and isobornyl (meth)acrylate; carboxyl group-containing monomers such as (meth) acrylic acid, itaconic acid, maleic acid, fumaric acid, crotonic acid and isocrotonic acid or anhydrides thereof; sulfonic group-containing monomers such as sodium vinyl sulfonate; aromatic vinyl compounds such as styrene and substituted styrene; cyano group-containing monomers such as acrylonitrile and methacrylonitrile; olefins or dienes such as ethylene, butadiene, isoprene and isobutylene; vinyl esters such as vinyl acetate; vinyl ethers such as a vinyl alkyl ether; vinyl chloride; amide group-containing monomers such as acrylamide, methacrylamide, N-vinylpyrrolidone and N,N-dimethyl (meth)acrylamide; hydroxyl group-containing monomers such as hydroxylalkyl (meth)acrylates, e.g. hydroxyethyl (meth) acrylate and hydroxypropyl (meth) acrylate, and glycerin dimethacrylate; amino group-containing monomers such as aminoethyl (meth)acrylate and (meth)acryloylmorpholine; imide group-containing monomers such as cyclohexyl maleimide and isopropyl maleimide; epoxy group-containing monomers such as glycidyl (meth) acrylate and methylglycidyl (meth)acrylate; isocyanate group-containing monomers such as 2-methacryloyloxyethyl isocyanate; and the like.

As the copolymerizable monomer, polyfunctional copolymerizable monomers (polyfunctional monomers) maybe used, and examples thereof include triethylene glycol di(meth)acrylate, diethylene glycol di(meth)acrylate, ethylene glycol di(meth)acrylate, tetraethylene glycol di(meth)acrylate, neopentyl glycol di(meth)acrylate, 1,6-hexanediol di(meth)acrylate, trimethylolpropane tri(meth)acrylate, pentaerythritol tri(meth)acrylate, dipentaerythritol hexa (meth) acrylate, divinylbenzene and the like. The copolymerizable monomers may be used either singly or in combination of two or more thereof.

In case of the surfactant-containing heat-expandable adhesive layer in which the heat-expandable adhesive layer is an adhesive surface, the adhesive constituting the surfactant-containing heat-expandable adhesive layer is preferably an adhesive having low contamination. The adhesive having low contamination includes a rubbery adhesive or an acrylic adhesive containing a low-molecular polymer component with a weight average molecular weight of. 100,000 or less at a ratio of 15% by weight or less (preferably 10% by weight or less, more preferably 5% by weight or less, especially 1% by weight or less), based on all polymer components, and the like. Further, it includes a radiation-curable adhesive which is cured such that after curing, a ratio of a low-molecular polymer component with a weight average molecular weight of 100,000 or less is 15% by weight or less (preferably 10% by weight or less, more preferably 5% by weight or less, especially 1% by weight or less) based on all polymer components.

(Surfactant)

In the heat-expandable adhesive layer, the surfactant-containing heat-expandable adhesive layer further contains the surfactant. As the surfactant, various surfactants (for example, a nonionic surfactant, an anionic surfactant, a cationic surfactant and an ampholytic surfactant) are available. The surfactants may be used either singly or in combination of two or more thereof.

As the surfactant, the nonionic surfactant can preferably be used. Examples of the nonionic surfactant include ether-based nonionic surfactants such as polyoxyethylenealkylphenyl ethers (polyoxyethyleneoctylphenyl ether, polyoxyethylenenonylphenyl ether, polyoxyethylenedodecyl-phenyl ether and the like), polyoxyethylenealkyallyl ethers, polyoxyethylenealkyl ethers (polyoxyethyleneoleyl ether, polyoxyethylenelauryl ether and the like) and a polyoxyethylene polyoxypropylene block polymer; ester ether-based nonionic surfactants such as polyethylene glycol fatty acid esters (polyethylene glycol oleic acid ester and the like) and polyoxyethylenesorbitan fatty acid esters (polyoxyethylenesorbitan monopalmitic acid ester and the like); ester-based nonionic surfactants such as glycerin fatty acid esters (glycerin monostearic acid ester and the like), sorbitan fatty acid esters (sorbitan monostearic acid ester and the like), sucrose fatty acid esters (sucrose stearic acid ester and the like); alkanolamide-based nonionic surfactants such as fatty acid alkanol amides (lauric acid diethanolamide and the like); and the like. Preferable examples of the nonionic surfactant include ether-based nonionic surfactants (especially, polyoxyethylenealkylphenyl ethers and polyoxyethylenealkyl ethers).

As the anionic surfactant, various anionic surfactants such as a phosphoric acid ester-based anionic surfactant, a sulfuric acid ester-based anionic surfactant, a sulfonic acid-based anionic surfactant and a carboxylic acid-based anionic surfactant are available. As the cationic surfactant, various cationic surfactants such as an amine salt-based cationic surfactant and a quaternary ammonium salt-based cationic surfactant are available. As the ampholytic surfactant, various ampholytic surfactants such as a carboxybetaine-based ampholytic surfactant and a glycine-based ampholytic surfactant are available.

As the surfactant, a surfactant having HLB (Hydrophile-Lipophile-Balance) of 10 or more (preferably 13 or more) can preferably be used. When HBL of the surfactant is 10 or more, the surfactant can efficiently be bled from the adhesive layer to the surface of the adhesion body.

Accordingly, as the surfactant in the surfactant-containing heat-expandable adhesive layer, a nonionic surfactant having HLB of 10 or more (preferably 13 or more) is preferable.

The addition amount of the surfactant can be selected from the range of, for example, from 0.01 to 10 parts by weight (preferably from 0.05 to 5 parts by weight, more preferably from 0.1 to 2 parts by weight), based on 100 parts by weight of the base polymer of the adhesive constituting the surfactant-containing heat-expandable adhesive layer.

The heat-expandable adhesive layer (surfactant-containing heat-expandable adhesive layer or surfactant-free heat-expandable adhesive layer) can be formed by, for example, an ordinary method in which an adhesive, a foaming agent (especially heat-expandable microcapsules) and as required, a surfactant, a solvent and other additives are mixed and the mixture is formed into a sheet-like layer. Specifically, the surfactant-containing or surfactant-free heat-expandable adhesive layer can be formed by, for example, a method in which a mixture of an adhesive, a foaming agent such as heat-expandable microcapsules and as required, a surfactant, a solvent and other additives is coated on a substrate or a rubbery organic elastic layer to be described later, or a method in which the mixture is coated on an appropriate separator (separate paper or the like) to form a heat-expandable adhesive layer which is then transferred (moved) onto a substrate or a rubbery organic elastic layer.

The heat-expandable adhesive layer (surfactant-containing heat-expandable adhesive layer or surfactant-free heat-expandable adhesive layer) may be in the form of a monolayer or a multilayer.

The thickness of the heat-expandable adhesive layer (surfactant-containing heat-expandable adhesive layer or surfactant-free heat-expandable adhesive layer) can properly be selected depending on the decrease in adhesivity or the like. It is, for example, 500 μm or less (preferably from 5 to 200 μm). When the thickness is too large, cohesive failure occurs in the heat-expandable adhesive layer in peeling after heat treatment, whereby the adhesive remains on the semiconductor wafer and the semiconductor wafer tends to be contaminated excessively. Meanwhile, when the thickness of the heat-expandable adhesive layer is too small, the degree of deformation of the heat-expandable adhesive layer by heat treatment is low. Thus, the adhesivity is not smoothly decreased, or the particle size of the heat-expandable microcapsules to be added has to be decreased excessively.

(Surfactant-Containing Adhesive Layer)

The non-heat-expandable adhesive layer containing the surfactant, such as the surfactant-containing adhesive layer 8 shown in FIG. 2 is an adhesive layer free of the foaming agent (heat-expandable microcapsules or the like) and having no heat expansibility. Such a surfactant-containing adhesive layer comprises at least an adhesive for imparting adhesivity and a surfactant. Accordingly, the surfactant-containing adhesive layer corresponds to the surfactant-containing heat-expandable adhesive layer from which the foaming agent (heat-expandable microcapsules or the like) is removed. The surfactant-containing adhesive layer is used as an adhesive layer which is adhered to the adhesion body. Further, the surfactant-containing adhesive layer is used for preventing an increase in contamination (especially, micro-contamination) of the adhesion body with the heat-expandable adhesive layer in decreasing the adhesivity by heating. Such a surfactant-containing adhesive layer decreases the adhesivity to the adhesion body by expansion of the heat-expandable adhesive layer (surfactant-free heat-expandable adhesive layer), whereby the heat-peelable pressure-sensitive adhesive sheet can easily be peeled from the adhesion body.

As the adhesive used in the surfactant-containing adhesive layer, known ordinary adhesives (for example, a rubbery adhesive, an acrylic adhesive, a styrene-diene block copolymer adhesive, a vinyl alkyl ether adhesive, a silicone-based adhesive, a polyester-based adhesive, a polyamide-based adhesive, a urethane-based adhesive, a fluorine-based adhesive, a creeping property-improved adhesive and a radiation-curable adhesive) which are the same as those used in the surfactant-containing heat-expandable adhesive layer are available. The adhesives may be used either singly or in combination of two or more thereof.

The adhesive may contain, other than a polymer component such as an adhesive component (base polymer), appropriate additives, depending on the type of the adhesive and the like, such as a crosslinking agent, an adhesivity-imparting resin (resins which are solid, semi-solid or liquid at room temperature, such as a rosin derivative resin, a polyterpene resin, a petroleum resin and an oil-soluble phenolic resin), a plasticizer, a filler and an antioxidant. The adhesive layer using a polymer with a functional group introduced as a base polymer and crosslinked by addition of a crosslinking agent has cohesive force and can reduce contamination caused by the adhesive layer. However, in the use in which transfer of the additives into the adhesion body poses a problem as in case of desiring low contamination, an adhesive of a composition that does not contain the additives such as the adhesivity-imparting resin and the plasticizer is also available. The crosslinking agent is not particularly limited.

Examples thereof include isocyanate-based crosslinking agents such as tolylene diisocyanate, trimethylolpropane triisocyanate and diphenylmethane diisocyanate; epoxy-based crosslinking agents such as polyethylene glycol diglycidyl ether, diglycidyl ether and trimethylolpropane triglycidyl ether; melamine-based crosslinking agents such as an alkyl ether melamine compound; metal salt-based crosslinking agents; metal chelate-based crosslinking agents; amino-based crosslinking agents; peroxide-based crosslinking agents; coupling agent-type crosslinking agents such as a silane coupling agent; and the like.

As the adhesive, a rubbery adhesive and an acrylic adhesive (especially an acrylic adhesive) can preferably be used as in the heat-expandable adhesive layer. Specific examples of the base polymer and the like in the rubbery adhesive and the acrylic adhesive are the same as those listed above. The adhesive constituting the surfactant-containing adhesive layer is, like the adhesive constituting the surfactant-containing heat-expandable adhesive layer, preferably an adhesive having low contamination. The adhesive having low contamination includes a rubbery adhesive or an acrylic adhesive containing a low-molecular polymer component with a weight average molecular weight of 100,000 or less at a ratio of 15% by weight of less (preferably 10% by weight or less, more preferably 5% by weight or less, especially 1% by weight or less), based on all polymer components, and the like. Further, it includes a radiation-curable adhesive which is cured such that after curing, a ratio of a low-molecular polymer component with a weight average molecular weight of 100,000 or less is 15% by weight or less (preferably 10% by weight or less, more preferably 5% by weight or less, especially 1% by weight or less) based on all polymer components.

As the surfactant used in the surfactant-containing adhesive layer, surfactants which are the same as those used in the surfactant-containing heat-expandable adhesive layer (for example, a nonionic surfactant, an anionic surfactant, a cationic surfactant and an ampholytic surfactant) are available. Of these, a nonionic surfactant can preferably be used. As the nonionic surfactant, the foregoing nonionic surfactants can be used. Specific examples thereof include ether-based nonionic surfactants such as polyoxyethylenealkylphenyl ethers (polyoxyethyleneoctylphenyl ether, polyoxyethylenenonylphenyl ether, polyoxyethylenedodecylphenyl ether and the like), polyoxyethylenealkylallyl ethers, polyoxyethylenealkyl ethers (polyoxyethyleneoleyl ether, polyoxyethylenelauryl ether and the like) and a polyoxyethylene polyoxypropylene block polymer; ester ether-based nonionic surfactants such as polyethylene glycol fatty acid esters (polyethylene glycol oleic acid ester and the like) and polyoxyethylene sorbitan fatty acid esters (polyoxyethylenesorbitan monopalmitic acid ester and the like); ester-based nonionic surfactants such as glycerin fatty acid esters (glycerin monostearic acid ester and the like), sorbitan fatty acid esters (sorbitan monostearic acid ester and the like), sucrose fatty acid esters (sucrose stearic acid ester and the like); alkanolamide-based nonionic surfactants such as fatty acid alkanol amides (lauric acid diethanolamide and the like); and the like.

Preferable examples of the nonionic surfactant include ether-based nonionic surfactants (especially, polyoxyethylenealkylphenyl ethers and polyoxyethylenealkyl ethers).

As the anionic surfactant, various anionic surfactants such as a phosphoric acid ester-based anionic surfactant, a sulfuric acid ester-based anionic surfactant, a sulfonic acid-based anionic surfactant and a carboxylic acid-based anionic surfactant are available. As the cationic surfactant, various cationic surfactants such as an amine salt-based cationic surfactant and a quaternary ammonium salt-based cationic surfactant are available. As the ampholytic surfactant, various ampholytic surfactants such as a carboxybetaine-based ampholytic surfactant and a glycine-based surfactant are available.

As the surfactant, a surfactant having HLB of 10 or more (preferably 13 or more) can preferably be used, as mentioned above, for efficiently bleeding the surfactant from the adhesive layer to the surface of the adhesion body.

Accordingly, as the surfactant in the surfactant-containing adhesive layer, a nonionic surfactant having HLB of 10 or more (preferably 13 or more) is preferable.

The addition amount of the surfactant can be selected from the range of, for example, from 0.01 to 10 parts by weight (preferably from 0.05 to 5 parts by weight, more preferably from 0.1 to 2 parts by weight), based on 100 parts by weight of the base polymer of the adhesive constituting the surfactant-containing adhesive layer.

The surfactant-containing adhesive layer can be formed by, for example, an ordinary method in which an adhesive, a surfactant and as required, a solvent and other additives are mixed and the mixture is formed into a sheet-like layer. Specifically, the surfactant-containing adhesive layer can be formed by, for example, a method in which a mixture of an adhesive, a surfactant and as required, a solvent and other additives is coated on a heat-expandable adhesive layer, or a method in which the mixture is coated on an appropriate separator (separate paper or the like) to form a surfactant-containing adhesive layer which is then transferred (moved) onto a heat-expandable adhesive layer.

The surfactant-containing adhesive layer may be in the form of a monolayer or a multilayer.

The thickness of the surfactant-containing adhesive layer is not particularly limited, and can properly be selected according to the use purpose of the heat-peelable pressure-sensitive adhesive sheet, the decrease in adhesivity by heating and the like. Generally, when the thickness of the surfactant-containing adhesive layer is too small, insufficient adhesivity or cohesive failure in irregular deformation of the heat-expandable adhesive layer by heating is liable to occur. Meanwhile, when the thickness of the surfactant-containing adhesive layer is too large, it can hardly follow up the irregular deformation of the heat-expandable adhesive layer by heating.

Accordingly, in view of the prevention of the cohesive failure in heat deformation (further, prevention of the increase of a contaminant on the surface of the adhesion body such as the semiconductor wafer), the follow-up of the irregular deformation of the heat-expandable adhesive layer (further, the decrease or the loss of the adhesivity to the adhesion body such as the semiconductor wafer) and the like, it is advisable that the thickness of the surfactant-containing adhesive layer is, for example, 20 μm or less (preferably from 0.1 to 10 μm, more preferably from 1 to 5 μm).

When the heat-peelable pressure-sensitive adhesive sheet has the surfactant-containing heat-expandable adhesive layer, it is advisable that the surfactant-containing heat-expandable adhesive layer is formed on at least one surface of the substrate. Examples thereof include (1a) a heat-peelable pressure-sensitive adhesive sheet of a structure that the surfactant-containing heat-expandable adhesive layer is formed on one surface of a substrate, (1b) a heat-peelable pressure-sensitive adhesive sheet of a structure that the surfactant-containing heat-expandable adhesive layer is formed on both surfaces of a substrate, (1c) a heat-peelable pressure-sensitive adhesive sheet of a structure that surfactant-containing heat-expandable adhesive layer is formed on one surface of a substrate and a surfactant-free heat-expandable adhesive layer or a surfactant-free non-heat-expandable adhesive layer is formed on another surface thereof as an adhesive layer which is an adhesive surface.

On the other hand, when the heat-peelable pressure-sensitive adhesive sheet has the heat-expandable adhesive layer and the surfactant-containing adhesive layer, it is advisable that the heat-expandable adhesive layer and the surfactant-containing adhesive layer are formed on at least one surface of a substrate in this order. Examples thereof include (2a) a heat-peelable pressure-sensitive adhesive sheet of a structure that the heat-expandable adhesive layer and the surfactant-containing adhesive layer are formed on one surface of a substrate in this order, (2b) a heat-peelable pressure-sensitive adhesive sheet of a structure that the heat-expandable adhesive layer and the surfactant-containing adhesive layer are formed on both surfaces of a substrate in this order, (2c) a heat-peelable pressure-sensitive adhesive sheet of a structure that the heat-expandable adhesive layer and the surfactant-containing adhesive layer are formed on one surface of a substrate in this order and the surfactant-free heat-expandable adhesive layer or the surfactant-free non-heat-expandable adhesive layer is formed on another surface thereof as an adhesive layer which is an adhesive surface, and the like.

When the heat-peelable pressure-sensitive adhesive sheet has a structure that the surfactant-containing heat-expandable adhesive layer or the surfactant-containing adhesive layer is formed on one surface of the substrate as the adhesive layer which is the adhesive surface and the adhesive layer (surfactant-containing heat-expandable adhesive layer, surfactant-containing adhesive layer, surfactant-free heat-expandable adhesive layer or surfactant-free non-heat-expandable adhesive layer) is also formed on another surface thereof [for example, the heat-peelable pressure-sensitive adhesive sheets of the structures (1b), (1c), (2b) and (2c)], the adhesive layer on another surface of the substrate can be used as, for example, an adhesive layer (adhesive layer for a support) to be adhered to the support.

In the heat-peelable pressure-sensitive adhesive sheet, for example, one or more intermediate layers (rubbery organic elastic layers or the like) may be formed between the substrate and the surfactant-containing heat-expandable adhesive layer or the heat-expandable adhesive layer.

(Adhesive Layer for a Support)

The adhesive layer for a support may be formed, as noted above, on the heat-peelable pressure-sensitive adhesive sheet. That is, the adhesive layer for a support may optionally be formed. As the support to which the adhesive layer for a support is adhered, a support seat in processing the semiconductor wafer or the like is mentioned. Accordingly, the adhesive layer for a support may be an adhesive layer for a support seat. When the adhesive layer for a support seat is thus provided, for example, the semiconductor wafer can be supported with the support seat using the adhesive layer for a support seat to process the semiconductor wafer more easily.

The adhesive for forming the adhesive layer for a support is not particularly limited, and the known ordinary adhesives listed as the adhesive used in the heat-expandable adhesive layer or the surfactant-containing adhesive layer (for example, a rubbery adhesive, an acrylic adhesive, a styrene-diene block copolymer adhesive, a vinyl alkyl ether adhesive, a silicone-based adhesive, a polyester-based adhesive, a polyamide-based adhesive, a urethane-based adhesive, a fluorine-based adhesive, a creeping property-improved adhesive and a radiation-curable adhesive) are available. The adhesives may be used either singly or in combination of two or more thereof. The adhesive for forming the adhesive layer for a support may contain known ordinary additives such as a crosslinking agent, an adhesivity-imparting agent, a plasticizer, a filler, an antioxidant and a surfactant.

When the adhesive layer for a support is the adhesive layer for a support seat in processing the semiconductor wafer, the adhesive layer for a support seat may be free from low contamination because it is not used in adhering the semiconductor wafer.

The thickness of the adhesive layer for a support may be, for example, 300 μm or less (for example, from 1 to 300 μm, preferably from 5 to 100 μm). As a method for forming the adhesive layer for a support, the same method as used in forming the heat-expandable adhesive layer or the surfactant-containing adhesive layer (for example, a method in which an adhesive layer is coated on a substrate, and a method in which an adhesive layer is formed by being coated on a separator and then transferred onto a substrate) can be utilized. The adhesive layer for a support maybe a monolayer or a multilayer.

(Intermediate Layer)

In the heat-peelable pressure-sensitive adhesive sheet, one or more intermediate layers may be formed, as described above, between the substrate and the surfactant-containing heat-expandable adhesive layer or the heat-expandable adhesive layer. Examples of the intermediate layer include a coating layer of a peeling agent for imparting peelability and a coating layer of an undercoating agent for improving adhesivity. Examples of the intermediate layer other than the coating layer of the peeling agent and the coating layer of the undercoating agent include a layer for imparting good deformability, a layer for increasing an adhesion area to the semiconductor wafer, a layer for improving adhesivity, a layer for satisfactorily following up the surface form of the semiconductor wafer, a layer for improving treatment of decreasing adhesivity by heating, a layer for improving peelability from the semiconductor wafer after heating, and the like.

Especially, it is preferable that a rubbery organic elastic layer is formed as an intermediate layer between the substrate and the surfactant-containing heat-expandable adhesive layer or the heat-expandable adhesive layer in view of imparting deformability of the heat-peelable pressure-sensitive adhesive sheet or improving peelability after heating. Thus, the rubbery organic elastic layer is provided, whereby the surface of the heat-peelable pressure-sensitive adhesive sheet (the surface of the surfactant-containing heat-expandable adhesive layer or the surfactant-containing adhesive layer) can satisfactorily follow up the surface form of the semiconductor wafer in adhering the heat-peelable pressure-sensitive adhesive sheet to the semiconductor wafer to increase the adhesion area. Further, when the heat-peelable pressure-sensitive adhesive sheet is heat-peeled from the semiconductor wafer, the heat expansion of the surfactant-containing heat-expandable adhesive layer or the heat-expandable adhesive layer is controlled highly (with good precision), and the surfactant-containing heat-expandable adhesive layer or the heat-expandable adhesive layer can be expanded in a thickness direction preferentially and uniformly. Further, even when the particle size of the heat-expandable microcapsules contained in the surfactant-containing heat-expandable adhesive layer or the heat-expandable adhesive layer may be somewhat large, the unevenness ascribable thereto is absorbed with the rubbery organic elastic layer, making it possible to minimize the surface roughness of the surfactant-containing heat-expandable adhesive layer or the heat-expandable adhesive layer. Incidentally, the rubbery organic elastic layer is a layer which is provided as required, and it is not necessarily provided.

It is preferable that the rubbery organic elastic layer is formed on the surface, at the substrate side, of the surfactant-containing heat-expandable adhesive layer or the heat-expandable adhesive layer in a superposed state. It can be formed as a layer other than the intermediate layer between the substrate and the surfactant-containing heat-expandable adhesive layer or the heat-expandable adhesive layer. The rubbery organic elastic layer can be provided on one or both surfaces of the substrate.

It is preferable that the rubbery organic elastic layer is formed of, for example, a natural rubber, a synthetic rubber or a synthetic resin with rubber elasticity having Shore D-type hardness of 50 or less, especially 40 or less as measured according to ASTM D-2240.

Examples of the synthetic rubber or the synthetic resin with rubber elasticity include nitrile-type, diene-type and acrylic synthetic rubbers; polyolefin-type and polyester-type thermoplastic elastomers; and synthetic resins with rubber elasticity, such as an ethylene-vinyl acetate copolymer, polyurethane, polybutadiene and soft polyvinyl chloride. A substantially hard polymer such as polyvinyl chloride can exhibit rubber elasticity in combination with additives such as a plasticizer and a softening agent. Such a composition can be used as a constituent material of the rubbery organic elastic layer. Adhesive materials such as an adhesive constituting the heat-expandable adhesive layer can preferably be used as a constituent material of the rubbery organic elastic layer.

The rubbery organic elastic layer can be formed by a method in which a coating solution containing a rubbery organic elastic layer-forming material such as the natural rubber, the synthetic rubber or the synthetic resin with rubber elasticity is coated on a substrate (coating method), a method in which a film made of the rubbery organic elastic layer-forming material or a laminate film in which a layer made of the rubbery organic elastic layer-forming material is previously formed on one or more heat-expandable adhesive layers is adhered to a substrate (dry-laminating method), a method in which a resin composition containing a constituent material of a substrate and a resin composition containing the rubbery organic elastic layer-forming material are co-extruded (co-extrusion method), or the like.

The thickness of the rubbery organic elastic layer is generally 500 μm or less (for example, from 1 to 500 μm), preferably from 3 to 300 μm, more preferably from 5 to 150 μm. The rubbery organic elastic layer may be in the form of a monolayer or a multilayer.

When a radiation-curable substance is used in the adhesive layer of the heat-expandable adhesive layer such as the surfactant-containing heat-expandable adhesive layer or the surfactant-free heat-expandable adhesive layer, the surfactant-containing adhesive layer or the adhesive layer for a support, it is advisable that a substance that does not hinder transmission of radiation is used in the rubbery organic elastic layer.

The intermediate layer (rubbery organic elastic layer or the like) may be formed on a site other than a site between the substrate and the adhesive layer for a support.

(Separator)

As the separator such as the separator 4 shown in FIG. 1 or the separator 9 shown in FIG. 2, an ordinary separate paper or the like is available. The separator is used as a protective material of the adhesive layer as the adhesive surface, such as the surfactant-containing heat-expandable adhesive layer, the surfactant-containing adhesive layer, the adhesive layer for a support or the like, and it is peeled when the heat-peelable pressure-sensitive adhesive sheet is adhered to the adhesion body (such as the semiconductor wafer or the support seat). The separator is not necessarily provided.

As the separator, substrates having release layers such as a plastic film and paper surface-treated with silicone based, long-chain-alkyl-based, fluorine-based and molybdenum sulfide release agents; low-adhesion substrates made of fluropolymers such as polytetrafluoroethylene, polychlorotrifluoroethylene, polyvinyl fluoride, polyvinylidene fluoride, a tetrafluoroethylene-hexafluropropylene copolymer and a chlorofluoroethylene-vinylidene fluoride copolymer; low-adhesion substrates made of non-polar polymers such as olefinic resins (for example, polyethylene and polypropylene) can be used. The separator may be used as a substrate for supporting various adhesive layers such as the heat-expandable adhesive layers, e.g. the surfactant-containing heat-expandable adhesive layer and the surfactant-free heat-expandable adhesive layer, the surfactant-containing adhesive layer and the adhesive layer for a support.

The separator can be formed by a known ordinary method. The thickness and the like of the separator are not particularly limited.

In the invention, the heat-peelable pressure-sensitive adhesive sheet may take the form of a sheet, a tape or the like. As the heat-peelable pressure-sensitive adhesive sheet (tape) in the rolled condition or shape, it may have a structure, as noted above, that the adhesive layer (adhesive layer of the surfactant-containing heat-expandable adhesive layer, the surfactant-containing adhesive layer or the like) as the adhesive surface is protected with the separator. It may have a structure that the adhesive layer (adhesive layer of the surfactant-containing heat-expandable adhesive layer, the surfactant-containing adhesive layer or the like) as the adhesive surface is formed on one surface of a substrate and a peeling treatment layer (reverse surface treatment layer) is formed on another surface thereof.

(Use)

The heat-peelable pressure-sensitive adhesive sheet of the invention can be used in various applications of ordinary adhesive sheets, such as adhesion of the adhesion body. The sheet has such a property that it can be adhered with strong adhesivity and easily be separated from the adhesion body by decreasing the adhesivity through heat treatment at any time. Thus, it can advantageously be used in applications in which these characteristics can effectively be exhibited (for example, an application in which after the sheet is adhered to an adhesion body for a predetermined period of time, the adhered state is required or desired to be released). The adhesion body is not particularly limited. Examples of its material include arbitrary materials such as metals, ceramics, plastics, wood and paper. The shape of the adhesion body is not particularly limited, and any shape will do. Specifically, with respect to the shape of the adhesion body, for example, the adhered surface to which the heat-peelable pressure-sensitive adhesive sheet is adhered may take any of a flat (plate) shape, a curved shape, a fibrous shape and the like.

Especially, in the heat-peelable pressure-sensitive adhesive sheet of the invention, the surfactant is contained in the adhesive layer (heat-expandable adhesive layer or non-heat-expandable adhesive layer) as the adhesive surface. Accordingly, even though the surface (adhered surface) to which the heat-peelable pressure-sensitive adhesive sheet has been adhered in the adhesion body is contaminated with a component derived from the adhesive component in the adhesive layer by decreasing adhesivity through heating after peeling the sheet from the adhesion body by heat treatment, the contaminant on the adhered surface of the adhesion body can easily be removed by water washing of the adhesion body (especially the adhered surface of the adhesion body). Specifically, the surfactant component contained in the adhesive layer (heat-expandable adhesive layer or non-heat expandable adhesive layer) as the adhesive surface in the heat-peelable pressure-sensitive adhesive sheet is bled on the adhesion boundary, namely the surface of the adhesion body. Accordingly, the component (contaminant) derived from the adhesive component and the surfactant remain on the surface of the adhesion body after decreasing adhesivity through heating. Therefore, the component (contaminant) derived from the adhesive component remaining on the surface of the adhesion body is easily removed by water washing. Even though the surface of the adhesion body is contaminated in heat-treating the heat-peelable pressure-sensitive adhesive sheet to decrease the adhesivity, the adhesion body can easily be cleaned by a simple method such as water washing to decrease contamination. For this reason, as the adhesion body, a material capable of water washing can preferably be used.

Accordingly, the heat-peelable pressure-sensitive adhesive sheet of the invention can be adhered with strong adhesivity in processing, and the adhered state can be released after processing. Besides, the sheet is advantageously used in an application in which it is desired to less contaminate the surface of the adhesion body. As the adhesion body used in such an application, for example, a semiconductor wafer is mentioned. That is, in the semiconductor wafer, the component derived from the adhesive component poses a problem as a contaminant.

Accordingly, the adhesion body may be the semiconductor wafer. For this reason, the heat-peelable pressure-sensitive adhesive sheet can be used as, for example, a heat-peelable pressure-sensitive adhesive sheet employed in processing the semiconductor wafer. Specifically, when the adhesion body is the semiconductor wafer, examples of the processing of the semiconductor wafer include various processings such as reverse surface polishing treatment, dicing treatment and fine treatment of the semiconductor wafer. In such processings, the heat-peelable pressure-sensitive adhesive sheet has a function of protecting the semiconductor wafer in processing and a function of fixing or supporting the same.

In processing the semiconductor wafer, after a circuit pattern is formed on the surface of the semiconductor wafer, an adhesive film for protection is adhered to the surface (circuit pattern-formed surface) of the semiconductor wafer for preventing contamination or breakage on the circuit pattern-formed surface of the semiconductor wafer, and the reverse surface of the semiconductor wafer is then cut. After cutting the reverse surface, the adhesive film for protection is peeled, and the surface of the semiconductor wafer is diced. In this treatment, cooling water or cleaning water is usually sprayed on the circuit pattern-formed surface as a top surface. Accordingly, when the heat-peelable pressure-sensitive adhesive sheet is used as an adhesive film for protection in cutting the reverse surface of the semiconductor wafer, the reverse surface of the semiconductor wafer is cut, and the heat-peelable pressure-sensitive adhesive sheet is peeled by heat treatment, after which the component (contaminant) derived from the adhesive component remaining on the surface of the semiconductor wafer can be removed by water washing with cooling water or cleaning water sprayed on the surface of the semiconductor wafer in the dicing treatment.

Therefore, when the heat-peelable pressure-sensitive adhesive sheet is used as the adhesive film for protection in a step of cutting the semiconductor wafer, the contaminant (contaminant derived from the adhesive layer) adhered to the surface of the semiconductor wafer can be removed in the dicing step subsequent to the cutting step without separately providing a washing step. Consequently, when the heat-peelable pressure-sensitive adhesive sheet of the invention is used, the contamination on the surface of the semiconductor wafer can be reduced even by using an ordinary equipment as such in the processing method of the semiconductor wafer. For this reason, there is no need to newly provide a washing step or to use special water as cooling water or cleaning water in the dicing step.

The semiconductor wafer as the adhesion body is not particularly limited so long as it is a known ordinary semiconductor wafer. A silicon wafer can preferably be used. Specific examples of the adhesion body other than the semiconductor wafer include a multilayer substrate, laminated ceramics, a once-sealable module and the like. The adhesion bodies other than the semiconductor wafer can of course be subjected to various processings by surface protection or fixing (temporal-fixing) using the heat-peelable pressure-sensitive adhesive sheet.

The heat-peelable pressure-sensitive adhesive sheet is used by adhering the adhesive surface of the surfactant-containing heat-expandable adhesive layer or the surfactant-containing adhesive layer to the adhesion body (semiconductor wafer or the like) to be processed. In this case, a support may be adhered to another surface of the heat-peelable pressure-sensitive adhesive sheet for supporting the adhesion body more strongly. As the support, a known ordinary support seat can be used when the adhesion body to be processed is the semiconductor wafer. Examples of such a support seat include a stainless steel plate, a glass plate, a dummy wafer and the like. The support seat can properly be selected depending on the type of the semiconductor wafer, the processing method of the semiconductor wafer and the like.

When the semiconductor wafer is thus processed using the heat-peelable pressure-sensitive adhesive sheet of the invention, the contamination on the surface of the semiconductor wafer by the heat-peelable pressure-sensitive adhesive sheet can be reduced. Specifically, when the heat-peelable pressure-sensitive adhesive sheet of the invention is adhered to a surface of the semiconductor wafer, a carbon element ratio R_{C1} (%) on the surface of the semiconductor wafer, as measured by XPS, after the heat-peelable pressure-sensitive adhesive sheet is peeled from the semiconductor wafer by heating and the semiconductor wafer is further washed with water satisfies the following relational expression (1):
R_{C1}≦50+R_{C2} (1)
wherein R_{C2} represents a carbon element ratio (%) on the surface of the semiconductor wafer, as measured by XPS, before adhered to the heat-peelable pressure-sensitive adhesive sheet and before providing a water-soluble protective layer.

That is, a difference [R_{C1}−R_{c2}] (sometimes referred to as “ΔR_{C1-2}”) between a carbon element ratio R_{C1} (%) on a surface (surface to which the heat-peelable pressure-sensitive adhesive sheet has been adhered) of the semiconductor wafer (such as a silicon wafer or the like), as measured by XPS, after the heat-peelable pressure-sensitive adhesive sheet is adhered to the surface of the semiconductor wafer such that the surface of the surfactant-containing heat-expandable adhesive layer or the surfactant-containing adhesive layer of the heat-peelable pressure-sensitive adhesive sheet is adhered to the surface of the semiconductor wafer and the sheet is further supported with the support seat as required to subject the semiconductor wafer to desired processing, for example, and the heat-peelable pressure-sensitive adhesive sheet is then peeled from the semiconductor wafer by heating and the semiconductor wafer is further washed with water, and a carbon element ratio R_{C2} (%) on the surface of the semiconductor wafer, as measured by XPS, before the heat-peelable pressure-sensitive adhesive sheet is adhered thereto, can be set at 50 or less.

Especially when the semiconductor wafer is a silicon wafer, a carbon element ratio R_{C1}^{Si} on a surface of the silicon wafer, as measured by XPS, after the heat-peelable pressure-sensitive adhesive sheet is peeled from the silicon wafer by heating and the silicon wafer is further washed with water satisfies the following relational expression (2):
R_{C1}^{Si}≦2.5R_{Si} (2)
wherein R_{Si} represents a silicon element ratio (%) on the surface of the silicon wafer, as measured by XPS, after the heat-peelable pressure-sensitive adhesive sheet is peeled from the silicon wafer by heating and the silicon wafer is further washed with water.

That is, when the semiconductor wafer is a silicon wafer, a ratio [R_{C1}^{Si}/R_{Si}] (sometimes referred to as “R_{C/Si}”) of a carbon element ratio R_{C1}^{Si} (%) on a surface (surface to which the heat-peelable pressure-sensitive adhesive sheet has been adhered) of the silicon wafer, as measured by XPS, after the heat-peelable pressure-sensitive adhesive sheet is adhered to the surface of the silicon wafer such that the surface of the surfactant-containing heat-expandable adhesive layer or the surfactant-containing adhesive layer of the heat-peelable pressure-sensitive adhesive sheet is adhered to the surface of the silicon wafer and the sheet is supported by the support seat as required and, for example, after the silicon wafer is subjected to desired processing, the heat-peelable pressure-sensitive adhesive sheet is peeled from the silicon wafer by heating and the silicon wafer is further washed with water, and a silicon element ratio R_{Si} (%) on a surface (surface to which the heat-peelable pressure-sensitive adhesive sheet has been adhered) of the silicon wafer, as measured by XPS, after the heat-peelable pressure-sensitive adhesive sheet is adhered to the surface of the silicon wafer such that the surface of the surfactant-containing heat-expandable adhesive layer or the surfactant-containing adhesive layer of the heat-peelable pressure-sensitive adhesive sheet is adhered to the surface of the silicon wafer and the sheet is supported by the support seat as required and, for example, after the silicon wafer is subjected to desired processing, the heat-peelable pressure-sensitive adhesive sheet is peeled from the silicon wafer by heating and the silicon wafer is further washed with water, can be set at 2.5 or less.

In the invention, it is preferable to satisfy at least one of the relational expressions (1) and (2). Especially when the semiconductor wafer is a silicon wafer, it is preferable to satisfy both of the relational expressions (1) and (2).

ΔR_{C1-2} is not particularly limited so long as it is 50 or less. For example, it can be selected from the range of from 0 to 50 [preferably 30 or less (for example, from 0.1 to 30), more preferably 20 or less (from 0.5 to 20), especially preferably 5 or less (for example, from 1 to 5). ΔR_{C1-2} may be a minus value. When ΔR_{C1-2} exceeds 50, a degree of contamination on the surface of the semiconductor wafer to which the heat-peelable pressure-sensitive adhesive sheet has been adhered is increased, and parts obtained by processing, such as semiconductor chips, might be unacceptable parts which cannot be actually used.

R_{C/Si} is not particularly limited so long as it is 2.5 or less. For example, it can be selected from the range of from 0 to 2.5 [preferably 2.25 or less (for example, from 0.05 to 2.25), more preferably 1.5 or less (for example, from 0.1 to 1.5), especially 0.5 or less (for example, from 0.2 to 0.5)]. When R_{C/Si} exceeds 2.5, a degree of contamination on the surface of the semiconductor wafer to which the heat-peelable pressure-sensitive adhesive sheet has been adhered is increased, and parts obtained by processing, such as semiconductor chips, might be unacceptable parts which cannot actually be used.

The element ratio [carbon element ratio R_{C1} (carbon element ratio R_{C1}^{Si} when the semiconductor wafer is a silicon wafer) (%), carbon element ratio R_{C2} (%), silicon element ratio R_{Si} (%) or the like] is measured by XPS (X-ray Photoelectron Spectroscopy). Specifically, the carbon element ratio R_{C1} (%) or the silicon element ratio R_{Si} (%) according to XPS can be measured by, for example, adhering the heat-peelable pressure-sensitive adhesive sheet to the semiconductor wafer such that the surface of the surfactant-containing heat-expandable adhesive layer or the surfactant-containing adhesive layer is contacted with the surface of the semiconductor wafer, then conducting heat treatment in a hot air dryer of 130° C. for 10 minutes, peeling the heat-peelable pressure-sensitive adhesive sheet from the semiconductor wafer, washing the surface of the semiconductor wafer with water, and thereafter conducting X-ray photoelectron spectroscopy of the surface of the semiconductor wafer to which the heat-peelable pressure-sensitive adhesive sheet has been adhered using an X-ray photoelectron spectroscopic device (Model “5400”, manufactured by Albackfai) under conditions of an X-ray source: MgKα 15 KV (300 W), a withdrawal angle: 45° and a measurement area: 1×3.5 mm.

On the other hand, the carbon element ratio R_{C2} (%) according to XPS can be measured by conducting X-ray photoelectron spectroscopy of the surface of the semiconductor wafer before adhering the heat-peelable pressure-sensitive adhesive sheet using an X-ray photoelectron spectroscopic device (Model “5400”, manufactured by Albackfai) under conditions of an X-ray source: MgKα 15 KV (300 W), a withdrawal angle: 45° and a measurement area: 1×3.5 mm [with the same device under the same conditions as in measuring the carbon element ratio R_{C1} (%) or the silicon element ratio R_{Si} (%)].

The heat treatment in peeling the heat-peelable pressure-sensitive adhesive sheet from the semiconductor wafer can be conducted by an appropriate heating unit such as a hot plate, a hot air dryer, a near infrared lamp or an air dryer. The heating temperature can be above a temperature at which to start foaming of heat-expandable microcapsules in the heat-expandable adhesive layer. The heat treatment conditions can properly be determined depending on the decrease in adhesion area according to the surface condition of the semiconductor wafer, the type of the heat-expandable microcapsules or the like, the heat resistance of the substrate or the semiconductor wafer, the heating method (heat volume, heating unit or the like) and the like.

The general heat treatment conditions are that the temperature is from 100 to 250° C. and the time is from 5 to 90 seconds (hot plate or the like) or from 5 to 15 minutes (hot air dryer or the like). Under such heating conditions, the heat-expandable microcapsules of the heat-expandable adhesive layer are expanded and/or foamed, whereby the heat-expandable adhesive layer is expanded and deformed to allow irregular deformation which results in decreasing or losing the adhesivity. The heat treatment can be conducted at an appropriate stage according to the use purpose. Further, an infrared lamp or hot water may be used as a heating source.

Water washing in washing the surface of the semiconductor wafer with water is not particularly limited so long as it is washed with water. An appropriate washing method such as washing with running water or sonication in water (pure water sonication or the like) can be used. In case of the washing with running water, a flow rate, a flow velocity and the like are not particularly limited. In a dicing step in a semiconductor, a flow rate of cooling water or cleaning water is usually from 3 to 15 L/min (preferably from 5 to 15 L/min).

For example, a semiconductor chip can be obtained by processing the semiconductor wafer. Since the semiconductor chip formed of the semiconductor wafer processed using the heat-peelable pressure-sensitive adhesive sheet of the invention is low in contamination of its surface, it does not become an unacceptable product from this standpoint, and can be put to practical use. It is useful as a semiconductor chip for electronic parts, a semiconductor chip for a circuit substrate and the like.

### EXAMPLES

The invention is illustrated more specifically below by referring to Examples. However, the invention is not limited to these Examples.

### Example 1

A resin composition (mixture) comprising 100 parts by weight of an acrylic copolymer (acrylic copolymer containing 70 parts by weight of ethyl acrylate, 30 parts by weight of 2-ethylhexyl acrylate, 5 parts by weight of methyl methacrylate and 4 parts by weight of 2-hydroxyethyl acrylate as monomer components), 1.4 parts by weight of an isocyanate-based crosslinking agent (trade name, “Coronate L”, manufactured by Japan Polyurethane Kogyo K.K.), 0.30 parts by weight of heat-expandable microcapsules (trade name, “Matsumoto Microsphere F-501D”, manufactured by Matsumoto Yushi Seiyaku K.K.) and 1 part by weight of polyoxyethylenelauryl ether (trade name, “Noigen ET160”, manufactured by Dai-ichi Kogyo Seiyaku Co. Ltd.; HLB:16, nonionic surfactant) was prepared.

This mixture was coated on a polyester film (thickness: 5 μm) as a substrate such that the thickness after drying became 35 μm, and heat-dried to obtain a heat-peelable pressure-sensitive adhesive sheet having a layer structure of “a substrate/surfactant-containing heat-expandable adhesive layer (thickness 35 μm; adhesive surface)”.

### Example 2

A heat-peelable pressure-sensitive adhesive sheet was obtained in the same manner as in Example 1 except that 1 part by weight of polyoxyethyleneralkyl ether (trade name, “Noigen ET187” manufactured by Dai-ichi Kogyo Seiyaku Co., Ltd.; HLB:18, nonionic surfactant) was used as a surfactant. That is, the heat-peelable pressure-sensitive adhesive sheet has a layer structure of “a substrate/surfactant-containing heat-expandable adhesive layer (thickness 35 μm; adhesive surface)”.

### Example 3

A resin composition (mixture) comprising 100 parts by weight of an acrylic copolymer (acrylic copolymer containing 70 parts by weight of ethyl acrylate, 30 parts by weight of 2-ethylhexyl acrylate, 5 parts by weight of methyl methacrylate and 4 parts by weight of 2-hydroxyethyl acrylate as monomer components), 1.4 parts by weight of an isocyanate-based crosslinking agent (trade name, “Coronate L”, manufactured by Japan Polyurethane Kogyo K.K.) and 30 parts by weight of heat-expandable microcapsules (trade name, “Matsumoto Microsphere F-501D”, manufactured by Matsumoto Yushi Seiyaku K.K.) was prepared.

This mixture was coated on a polyester film (thickness: 50 μm) as a substrate such that the thickness after drying became 35 μm, and heat-dried to obtain a heat-expandable adhesive layer.

Further, a resin composition (mixture) comprising 100 parts by weight of an acrylic copolymer (acrylic copolymer containing 70 parts by weight of ethyl acrylate, 30 parts by weight of 2-ethylhexyl acrylate, 5 parts by weight of methyl methacrylate and 4 parts by weight of 2-hydroxyethyl acrylate as monomer components), 1.4 parts by weight of an isocyanate-based crosslinking agent (trade name, “Coronate L”, manufactured by Japan Polyurethane Kogyo K.K.) and 1 part by weight of polyoxyethylenelauryl ether (trade name, “Noigen ET160” manufactured by Dai-ichi Kogyo Seiyaku Co., Ltd.; HLB:16, nonionic surfactant) was prepared.

This mixture was coated on a separator such that the thickness after drying became 3 μm, and heat-dried to form a surfactant-containing non-heat-expandable adhesive layer (surfactant-containing adhesive layer).

The heat-expandable adhesive layer formed on the polyester film and the surfactant-containing adhesive layer formed on the separator were laminated such that they were contacted with each other to obtain a heat-peelable pressure-sensitive adhesive sheet having a layer structure of “a substrate/heat-expandable adhesive layer (thickness 35 μm)/surfactant-containing adhesive layer (thickness 30 μm; adhesive surface)”.

### Comparative Example 1

A heat-peelable pressure-sensitive adhesive sheet was obtained in the same manner as in Example 1 except that the surfactant was not used. That is, the heat-peelable pressure-sensitive adhesive sheet has a layer structure of “a substrate/heat-expandable adhesive layer (thickness 35 μm; adhesive surface)”.

### Comparative Example 2

A heat-peelable pressure-sensitive adhesive sheet was obtained in the same manner as in Example 3 except that the surfactant was not used. That is, the heat-peelable pressure-sensitive adhesive sheet has a layer structure of “a substrate/heat-expandable adhesive layer (thickness 35 μm)/non-heat-expandable adhesive layer (thickness 35 μm; free of the surfactant; adhesive surface)”.

(Evaluation of Adhesivity)

A polyester film having a thickness of 25 μm (trade name “Lumilar S-10”, manufactured by Toray Industries Inc.) was adhered to the adhesive surface of the heat-peelable pressure-sensitive adhesive sheet (cut to a width of 20 mm) obtained in each of Examples and Comparative Examples by one reciprocation of a 2 kg roller, and 180° peel adhesivity (N/20 mm) (peeling rate: 300 mm/min, temperature: 23±2° C., humidity: 65±5% RH, peeling the polyester film) before and after heating was measured with Shimadzu Autograph AGS-50D (manufactured by Shimadzu Corporation). The heat treatment was conducted in a hot air dryer of 130° C. for 3 minutes. The results of evaluation were shown in column “Adhesivity (N/20 mm)”.

(Measurement of the Number of Particles)

The heat-peelable pressure-sensitive adhesive sheet obtained in each of Examples and Comparative Examples was adhered to a mirror surface of a 4-inch silicon wafer (silicon wafer “CZ-N POLISHED WAFER (4 inches)” manufactured by Shin-Etsu Handotai Co., Ltd.) which had been subjected to mirror finish in a clean room, allowed to stand for 1 hour, and then heat-peeled at 130° C. In this case, the number of particles (number of particles/4-inch wafer) having a particle size of 0.28 μm or more on the mirror surface of the silicon wafer was measured with a laser surface inspection device “LS-5000” (manufactured by Hitachi Denshi Engineering K.K.). Subsequently, while water was sprayed onto the silicon wafer using a dicing device, the number of particles (number of particles/4-inch wafer) having a particle size of 0.28 μm or more on the mirror surface of the silicon wafer was likewise measured with the same laser surface inspection device “LS-5000” (manufactured by Hitachi Denshi Engineering K.K.).

(Evaluation of Contamination by XPS)

The heat-peelable pressure-sensitive adhesive sheet obtained in each of Examples and Comparative Examples is adhered to a mirror surface of a 4-inch silicon wafer (silicon wafer “CZ-N POLISHED WAFER” (4 inches) manufactured by Shin-Etsu Handotai Co., Ltd.) subjected to mirror finish in a clean room, allowed to stand for 1 hour, and then heat-peeled at 130° C. In this case, with respect to the silicon wafer, a carbon element ratio R_{C1}^{a} (%) on the surface is measured by XPS (X-ray Photoelectron Spectroscopy) using an X-ray photoelectron spectroscopic device, and a silicon element ratio R_{Si}^{a} (%) on the surface at this time is also measured simultaneously.

Further, with respect to the mirror surface of the original 4-inch silicon wafer (silicon wafer “CZ-N POLISHED WAFER (4 inches)” manufactured by Shin-etsu Semiconductor K.K.) subjected to mirror finish (mirror surface of the 4-inch silicon wafer subjected to mirror finish before adhering the adhesive sheet), a carbon element ratio R_{C2} (%) on the surface is likewise measured by XPS using the same X-ray photoelectron spectroscopic device.

Subsequently, the silicon wafer from which the heat-peelable pressure-sensitive adhesive sheet has been heat-peeled is cut to a square of 1 cm while spraying water using a dicing device (“DFD651”, manufactured by Disco), and a carbon element ratio R_{C1}^{b} (%) on the surface is likewise measured by XPS using the same X-ray photoelectron spectroscopic device, and a silicon element ratio R_{Si}^{b} (%) on the surface at this time is also measured simultaneously.

Using R_{C1}^{a}, R_{Si}^{a}, R_{C2}, R_{C1}^{b} and R_{Si}^{b} measured in this manner, a difference between R_{C1}^{a} and R_{C2} [R_{C1}^{a}−R_{C2} [=ΔR_{C1-2}^{a})] and an R_{C1}^{a} to R_{Si}^{a} (%) ratio [R_{C1}^{a}/R_{Si}^{a} (=R_{C/Si}^{a})] were obtained, and a difference between R_{C1}^{b} and R_{C2} [R_{C1}^{b}−R_{C2} (=ΔR_{C1-2}^{b})] and an R_{C1}^{b} to R_{Si}^{b} (%) ratio [R_{C1}^{b}/R_{Si}^{b} (=R_{C/Si}^{b})] were obtained to evaluate contamination. The results of evaluation were shown in respective columns of Table 1.

With respect to ΔR_{C1-2}^{a}, R_{C/Si}^{a}, ΔR_{C1-2}^{b} and R_{C/Si}^{b}, the larger the value, the higher the degree of contamination. Further, as the value after heating is larger than the value before heating, the degree of contamination is increased by heat treatment.

The measurement was conducted under conditions of an X-ray source: MgKα 15 KV (300 W), a withdrawal angle: 45° and a measurement area: 1×3.5 mm using an X-ray photoelectron spectroscopic device (Model “5400”, manufactured by Albackfai).

TABLE 1

| | | | Number of particles | | | | | |
|---|---|---|---|---|---|---|---|---|
| | Adhesivity | | (Number of | | ΔR_{C1-2} | | R_{C/Si} | |
| | (N/20 mm) | | particles/4 inches) | | Before | After | Before | After |
| | Before | After | Before | After | washing | washing | washing | washing |
| | heating | heating | washing | washing | ΔR_{C1-2}^{a} | R_{C/Si}^{a} | ΔR_{C1-2}^{b} | R_{C/Si}^{b} |
| Ex. 1 | 2.10 | 0 | 1720 | 43 | 18.9 | 2.5 | 0.83 | 0.31 |
| Ex. 2 | 2.75 | 0 | 2350 | 41 | 19.3 | 2.9 | 0.77 | 0.29 |
| Ex. 3 | 2.30 | 0 | 890 | 35 | 17.5 | 1.6 | 0.79 | 0.21 |
| Comp. | 3.53 | 0 | 1000 or | 1000 or | | | | |
| Ex. 1 | | | more | more | 22.2 | 21.0 | 0.85 | 0.83 |
| Comp. | 2.95 | 0 | 1000 or | 1000 or | | | | |
| Ex. 2 | | | more | more | 22.5 | 20.5 | 0.89 | 0.87 |

From Table 1, it is found that in Examples, ΔR_{C1-2}^{b} is by far smaller than ΔR_{C1-2}^{a}. Meanwhile, it is said that in Comparative Examples, there is almost no difference between ΔR_{C1-2}^{a} and ΔR_{C1-2}^{b}.

Further, in Examples, R_{C/Si}^{b} is by far smaller than R_{C/Si}^{a}. Meanwhile, it is said that in Comparative Examples, there is almost no difference between R_{C/Si}^{a} and R_{C/Si}^{b}.

Accordingly, it has been confirmed that the use of the heat-peelable pressure-sensitive adhesive sheet of the invention can hold the adhesion body (semiconductor wafer or the like) with satisfactory adhesivity in processing, the adhesive sheet can easily be peeled from the adhesion body by heat treatment and the contaminant (contaminant derived from the adhesive layer) on the surface of the adhesion body (semiconductor wafer or the like) can easily be reduced by water washing after the peeling by heat treatment.

While the invention has been described in detail and with reference to specific embodiments thereof, it will be apparent to one skilled in the art that various changes and modifications can be made therein without departing from the spirit and scope thereof.

The present application is based on Japanese Patent Application 2003-422313, filed on Dec. 19, 2003, and the entire disclosure thereof are incorporated herein by reference in its entirety.

1. A heat-peelable pressure-sensitive adhesive sheet, which comprises a substrate, a heat-expandable adhesive layer formed on at least one surface thereof, and a surfactant, wherein the surfactant is contained in the heat-expandable adhesive layer as an adhesive surface.

2. A heat-peelable pressure-sensitive adhesive sheet, which comprises a substrate, a heat-expandable adhesive layer formed on at least one surface thereof, a surfactant and a non-heat-expandable adhesive layer, wherein the surfactant is contained in the non-heat-expandable adhesive layer as an adhesive surface on the heat-expandable adhesive layer.

3. The heat-peelable pressure-sensitive adhesive sheet according to claim 1 or 2, which is a heat-peelable pressure-sensitive adhesive sheet used in processing a semiconductor wafer.

4. The heat-peelable pressure-sensitive adhesive sheet according to any one of claims 1 to 3, wherein when the heat-peelable pressure-sensitive adhesive sheet is adhered to the semiconductor wafer, a carbon element ratio R_{C1} (%) on a surface of the semiconductor wafer, as measured by XPS, after the heat-peelable pressure-sensitive adhesive sheet is peeled from the semiconductor wafer by heating and the semiconductor wafer is further washed with water satisfies the following relational expression (1):
R_{C1}≦50+R_{C2} (1)
wherein R_{C2} represents a carbon element ratio (%) on the surface of the semiconductor wafer, as measured by XPS, before adhered to the heat-peelable pressure-sensitive adhesive sheet.

5. The heat-peelable pressure-sensitive adhesive sheet according to any of claims 1 to 4, wherein when the heat-peelable pressure-sensitive adhesive sheet is adhered to the semiconductor wafer, the semiconductor wafer is a silicon wafer, and a carbon element ratio R_{C1}^{Si} on a surface of the silicon wafer, as measured by XPS, after the heat-peelable pressure-sensitive adhesive sheet is peeled from the silicon wafer by heating and the silicon wafer is further washed with water satisfies the following relational expression (2):
R_{C1}^{Si}≦2.5R_{Si} (2)
wherein R_{Si} represents a silicon element ratio (%) on the surface of the silicon wafer, as measured by XPS, after the heat-peelable pressure-sensitive adhesive sheet is peeled from the silicon wafer by heating and the silicon wafer is further washed with water.

6. The heat-peelable pressure-sensitive adhesive sheet according to any of claims 1 to 5, wherein at least one surfactant having HLB of 10 or more is contained as the surfactant.
